(19) United States
(12) Patent Application Publication
(10) Pub. No.: US 2026/0264619 A1
(43) Pub. Date: Sep. 10, 2026

(54) COVERING SHELF APPARATUS FOR A VEHICLE AND A CONTROL METHOD FOR SAME

(71) Applicants: HYUNDAI MOTOR COMPANY, Seoul (KR); KIA CORPORATION, Seoul (KR); SEOYON E-HWA CO., LTD., Anyang-si (KR)

(72) Inventors: Soonsung Park, Hwaseong-si (KR); ChanSeung Kim, Hwaseong-si (KR); Jung Won Yun, Uiwang-si (KR); Jae Moon Jeong, Namyangju-si (KR)

(73) Assignees: HYUNDAI MOTOR COMPANY, Seoul (KR); KIA CORPORATION, Seoul (KR); SEOYON E-HWA CO., LTD., Anyang-si (KR)

(21) Appl. No.: 19/247,020

(22) Filed: Jun. 24, 2025

(30) Foreign Application Priority Data
Mar. 6, 2025 (KR) 10-2025-0028790

(51) Int. Cl. B60R 5/04; F16C 1/00

(52) U.S. Cl. CPC B60R 5/045; F16C 1/00

(57) ABSTRACT

A covering shelf apparatus and control method for a vehicle. The covering shelf apparatus includes shelf sides, a covering shelf, an actuator, and first and second sensors. The shelf sides are provided at left and right sides of a luggage compartment, respectively. The actuator is provided at one shelf side and configured to move the covering shelf to enable the covering shelf to open or close the luggage compartment. The first sensor is provided at the shelf sides and configured to generate a first sensing signal upon sensing luggage disposed between the shelf sides. The second sensor is provided at a headliner and configured to generate a second sensing signal sensing luggage laid on an upper surface of the covering shelf. A controller operates the actuator when neither the first sensing signal nor the second sensing signal is generated.

### CROSS-REFERENCE TO RELATED APPLICATION

This present application claims priority to Korean Patent Application No. 10-2025-0028790, filed on Mar. 6, 2025, in the Korean Intellectual Property Office, the entire disclosure of which is incorporated herein by reference

### FIELD

The present disclosure relates to a covering shelf apparatus for a vehicle and a control method for the same, and more particularly to a covering shelf apparatus for a vehicle configured to shield a passenger compartment, in which a passenger rides, and a luggage compartment from each other and a control method for the same.

### BACKGROUND

Hatchback type vehicles such as sport utility vehicles (SUVs) and crossover utility vehicles (CUVs) are not equipped with a separate luggage compartment, and, in place, use a space between a rear seat and a tailgate as a luggage compartment. Accordingly, a covering shelf configured to shield a passenger compartment, in which a passenger rides, and a luggage compartment from each other is provided between a rear seat and a tailgate.

In association with this, U.S. Patent Application Publication No. 2019/0126837 (referred to as “Related Art 1” hereinafter) discloses a system for covering a motor-vehicle luggage compartment. The motor-vehicle luggage compartment covering system includes a front flap, a rear flap, a support, and a drive means.

The front flap is pivotably coupled to the support. The front flap and the rear flap are pivotably coupled to each other. A guide rail is mounted to the support. A shaft of the rear flap is movably mounted to the guide rail.

The drive means is mounted on the support. The drive means includes a carriage, a band, and a gear. The shaft of the rear flap is rotatably mounted on the carriage. The carriage is fixed to the band which has a closed loop shape. The band is engaged with pulleys respectively provided at ends of the rail. The gear slidably moves the carriage. As the carriage linearly moves along the rail, the front flap and the rear flap are folded or unfolded to open or close a luggage compartment.

U.S. Pat. No. 10,889,248 (referred to as “Related Art 2” hereinafter) discloses a system for covering the luggage compartment of a motor vehicle. The system for covering the luggage compartment of a motor vehicle includes lateral supports, a front panel, a rear panel, a carriage, a cable, and a wheel.

The front panel and the rear panel are pivotably coupled to the lateral supports, respectively. The carriage is slidably mounted on the guide rail. The cable is engaged with pulleys at opposite sides of a movement range of the carriage. The cable is rotated by frictional interaction with the wheel which rotates.

In accordance with Related Art 1 and 2, it may be possible to variously change a path of the cable by disposing the pulleys (the wheel or a drum) at positions where the direction of the cable (the band) is changed. However, when the covering shelf is driven by a motor, the covering shelf may strike luggage or may be jammed between adjacent items and, as such, the luggage or the covering shelf may be damaged.

Furthermore, when the covering shelf moves while luggage is stacked on the covering shelf by the user, the luggage may fall and, as such, the luggage or the covering shelf may be damaged. Therefore, a scheme capable of automatically sensing stacking of luggage when the covering shelf is driven, thereby preventing the covering shelf from jamming between adjacent items and damage to the covering shelf and the luggage is needed.

The statements in this section merely provide background information related to the present disclosure and may not constitute prior art.

### SUMMARY

The present disclosure is directed to addressing the above-mentioned issues, for application to a covering shelf apparatus for a vehicle configured to shield a passenger compartment, in which a passenger rides, and a luggage compartment from each other.

In detail, the present disclosure is directed to providing a covering shelf apparatus for a vehicle and a control method for the same which are capable of automatically sensing luggage disposed on a movement path of a covering shelf or stacked on an upper end of the covering shelf when the covering shelf operates, thereby preventing damage to the covering shelf and the luggage.

The present disclosure is directed to providing a covering shelf apparatus for a vehicle and a control method for the same which are capable of linking operating structures of a covering shelf and a tailgate to each other, thereby enabling the covering shelf to be opened or closed in linkage with the tailgate when the tailgate is opened or closed.

The present disclosure is directed to providing a covering shelf apparatus for a vehicle and a control method for the same which are capable of automatically informing the user of the luggage disposed on a movement path of a covering shelf or stacked on an upper end of the covering shelf.

The present disclosure is not limited to the above, and other technical aspects not mentioned above should be clearly understood by those having ordinary skill in the art from the following description.

A covering shelf apparatus for a vehicle disclosed in the present disclosure may include shelf sides, a covering shelf, an actuator, a first sensor, and a second sensor.

The shelf sides may be provided at left and right sides of a luggage compartment, respectively.

The actuator may be provided at one of the shelf sides and may be configured to move a covering shelf to enable the covering shelf to open or close the luggage compartment.

The first sensor may be provided at the shelf sides. The first sensor may generate a first sensing signal upon sensing luggage disposed between the shelf sides.

The second sensor may be provided at a headliner. The second sensor may generate a second sensing signal upon sensing luggage laid on an upper surface of the covering shelf.

A controller may operate the actuator when neither the first sensing signal nor the second sensing signal is generated.

The first sensor may be an area sensor.

An emitter of the first sensor may be provided at a first side of the shelf sides, and a receiver of the first sensor may be provided at a second side of the shelf sides.

The second sensor may be a photosensor.

The actuator may move the covering shelf by drive force of a motor.

A third sensor may be provided at the motor. The third sensor may generate a third sensing signal when a rotational speed of the motor decreases.

The controller may operate the actuator when the third sensing signal is not generated.

The actuator may include a carrier, a guide rail, a cable, and a driver.

The carrier may be connected to a first portion of the covering shelf.

The guide rail may be coupled to the shelf sides. The carrier may be movably mounted to the guide rail.

The cable may have a first end connected to the carrier and a second end may be a free end.

The driver may push and pull the cable to enable the covering shelf to cover or open the luggage compartment.

The cable may be a spiral cable.

The driver may include a gear and a motor.

The gear may transmit force to the cable while contacting the cable.

The motor may rotate the gear.

A control method for a covering shelf apparatus for a vehicle, which is disclosed in the present disclosure, may include: operating a first sensor and a second sensor (hereinafter an (a)-step), and stopping operation of the first sensor and the second sensor when neither the first sensing signal nor the second sensing signal is generated, and operating the actuator to enable the covering shelf to cover the luggage compartment (hereinafter a (b)-step).

The (a)-step may be executed when the controller receives a close signal from the tailgate while the tailgate is in an open state.

In the (b)-step, based on a determination that at least one of the first sensing signal or the second sensing signal is generated, generating, by the controller, a notification signal. Based on a determination that the controller receives a close signal from the covering shelf, the (a)-step may be executed again.

In the (b)-step, based on a determination that a third sensing signal is generated, stopping the operation of the actuator. Based on a determination that the controller receives a close signal from the covering shelf, the (a)-step may be executed again.

Based on a determination that the controller receives an open signal from the covering shelf, the (a)-step may be executed.

Based on a determination that the controller receives an open signal from the tailgate during the tailgate is in a closed state, the (a)-step may be executed.

In the (b)-step, based on a determination that at least one of the first sensing signal or the second sensing signal is generated, generating, by the controller, a notification signal. Based on a determination that the controller receives an open signal from the covering shelf, the (a)-step may be executed again.

In the (b)-step, based on a determination that the third sensing signal is generated, stopping the operation of the actuator. Based on a determination that the controller receives the open signal from the covering shelf, the (a)-step may be executed again.

### BRIEF DESCRIPTION OF THE DRAWINGS

The foregoing and other aspects, features, and advantages, as well as the following detailed description of the embodiments, should be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a perspective view of a covering shelf apparatus for a vehicle according to an embodiment of the present disclosure viewed from rear and top sides.

FIG. 2 is a perspective view of the covering shelf apparatus for a vehicle according to an embodiment of the present disclosure viewed from rear and bottom sides.

FIG. 3 is a partially-projected view of the covering shelf apparatus for a vehicle according to an embodiment of the present disclosure viewed from a lateral side, showing a state in which a covering shelf covers a luggage compartment.

FIG. 4 is a partially-projected view of the covering shelf apparatus for a vehicle according to an embodiment of the present disclosure viewed from a lateral side, showing a state in which the covering shelf has opened the luggage compartment.

FIG. 5 is a view of a driver of the covering shelf apparatus for a vehicle according to an embodiment of the present disclosure viewed at a lateral side.

FIG. 6 is a perspective view of a part of the covering shelf apparatus for a vehicle according to an embodiment of the present disclosure, showing a carrier and a guide rail.

FIG. 7 is an exploded perspective view of a part of the covering shelf apparatus for a vehicle according to an embodiment of the present disclosure, showing the carrier and the guide rail.

FIG. 8 is a perspective view of the covering shelf apparatus for a vehicle according to an embodiment of the present disclosure viewed at rear and top sides, showing a state in which luggage is stacked in the luggage compartment.

FIG. 9 is a diagram showing a controller, a first sensor, a second sensor, a third sensor, an actuator, and a tailgate of the covering shelf apparatus for a vehicle according to an embodiment of the present disclosure.

FIG. 10 is a sectional view of the covering shelf apparatus for a vehicle according to an embodiment of the present disclosure viewed at a rear side, showing a state in which luggage is not stacked in the luggage compartment.

FIG. 11 is a sectional view of the covering shelf apparatus for a vehicle according to an embodiment of the present disclosure viewed at a rear side, showing a state in which luggage is stacked in the luggage compartment.

FIG. 12 is a diagram showing a signal of a Hall sensor mounted to a motor according to an embodiment of the present disclosure.

FIG. 13 is a flowchart showing a control method for the covering shelf apparatus for a vehicle according to an embodiment of the present disclosure, showing a control method for the covering shelf apparatus for a vehicle when the tailgate is closed.

FIG. 14 is a flowchart showing a control method for the covering shelf apparatus for a vehicle according to an embodiment of the present disclosure, showing a control method for the covering shelf apparatus for a vehicle when the tailgate is opened.

### DETAILED DESCRIPTION OF THE DISCLOSURE

Hereinafter, embodiments of the present disclosure are described in detail with reference to the accompanying drawings. Description of known functions or configurations incorporated herein for description of the present disclosure may be omitted from the description of embodiments of the present disclosure.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

An X-direction, a Y-direction, and a Z-direction described in embodiments of the present disclosure may be directions perpendicular to one another. The X-direction and the Y-direction may be directions parallel to a horizontal direction, respectively, and the Z-direction may be a direction parallel to a vertical direction. When the X-direction is a direction parallel to a left/right direction, the Y-direction may be a direction parallel to a forward/rearward direction. When the X-direction is a direction parallel to the forward/rearward direction, the Y-direction may be a direction parallel to the left/right direction.

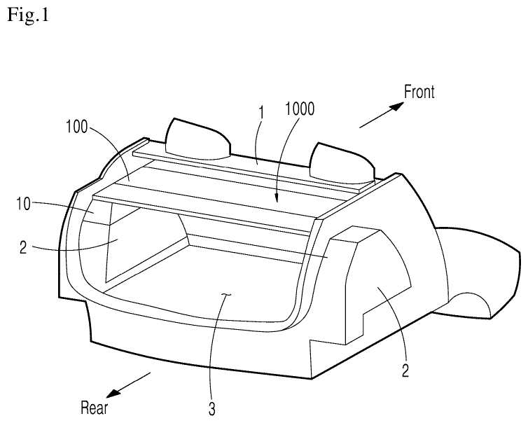

FIG. 1 is a perspective view of a covering shelf apparatus 1000 for a vehicle according to an embodiment of the present disclosure viewed from rear and top sides.

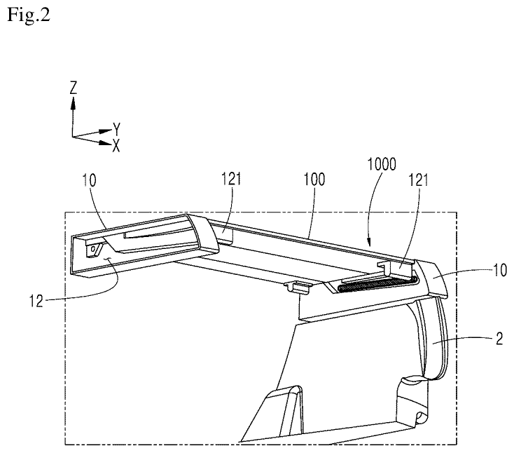

FIG. 2 is a perspective view of the covering shelf apparatus 1000 for a vehicle according to an embodiment of the present disclosure viewed from rear and bottom sides.

Hatchback type vehicles such as sport utility vehicles (SUVs) and crossover utility vehicles (CUVs) are not equipped with a separate luggage compartment, and, in place, use a space between a rear seat 1 and a tailgate as a luggage compartment 3. Accordingly, a covering shelf configured to shield a passenger compartment, in which a passenger rides, and the luggage compartment 3 from each other may be provided between the rear seat 1 and the tailgate.

The covering shelf apparatus 1000 for a vehicle according to an embodiment of the present disclosure may include a shelf side 10 and a covering shelf 100.

The shelf side 10 may be provided at each of left and right sides of the luggage compartment 3. A luggage side trim 2 may be provided at each of the left and right sides of the luggage compartment 3. The shelf side 10 may be provided over the luggage side trim 2.

The shelf side 10 may be coupled to an upper portion of the luggage side trim 2 by bolts, and the like. Alternatively, the shelf side 10 may be manufactured to be integrated with the luggage side trim 2.

The covering shelf 100 may cover and open an upper portion of the luggage compartment 3. The covering shelf 100 may cover the luggage compartment 3 through movement thereof in a first direction Y. The covering shelf 100 may cover the luggage compartment 3 through movement thereof in a direction-Y opposite to the first direction Y (referred to as a “second direction” hereinafter). The first direction Y may mean a rear side of a vehicle. The second direction may mean a front side of the vehicle.

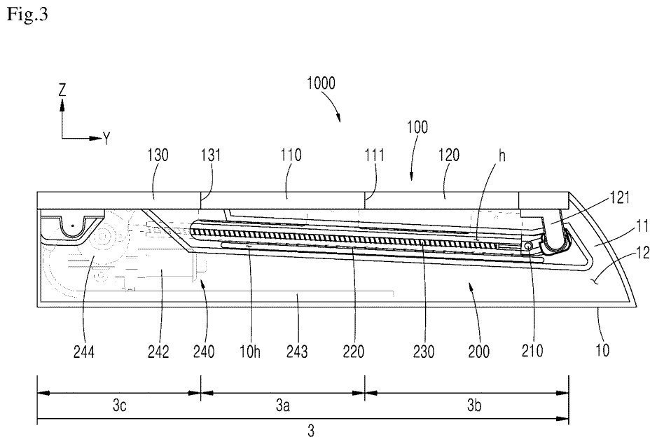

FIG. 3 is a partially-projected view of the covering shelf apparatus 1000 for a vehicle according to an embodiment of the present disclosure viewed from a lateral side, showing a state in which the covering shelf 100 covers the luggage compartment 3 (referred to as a “first state” hereinafter).

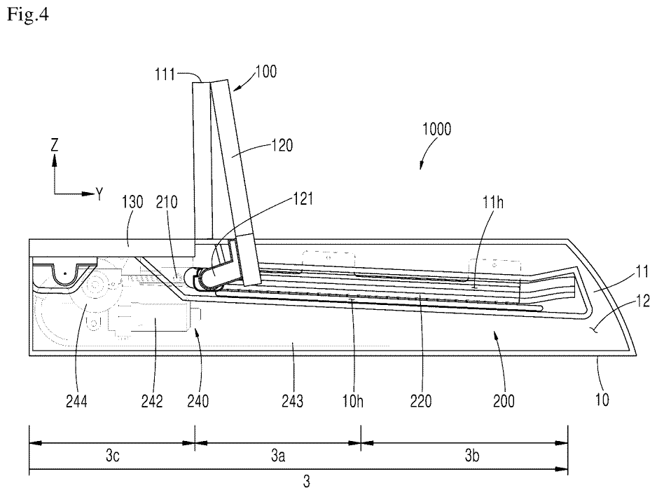

FIG. 4 is a partially-projected view of the covering shelf apparatus 1000 for a vehicle according to an embodiment of the present disclosure viewed from a lateral side, showing a state in which the covering shelf 100 has opened the luggage compartment 3 (referred to as a “second state” hereinafter).

The luggage compartment 3 may include a first luggage compartment 3a and a second luggage compartment 3b. The first luggage compartment 3a and the second luggage compartment 3b may be interconnected. The second luggage compartment 3b may be disposed farther ahead in the first direction Y than the first luggage compartment 3b.

The covering shelf 100 may include a first shelf 110, a second shelf 120, and a third shelf 130.

The first shelf 110 may cover and open the first luggage compartment 3a. The first shelf 110 may form a wide rectangular flat plate shape.

The second shelf 120 may cover and open the second luggage compartment 3b. The second shelf 120 may form a wide rectangular flat plate shape. The second shelf 120 may be pivotably coupled to an end 111 of the first shelf 110 (referred to as a “first end” hereinafter). The first shelf 110 and the second shelf 120 may be interconnected by fabric, leather, a hinge, and the like.

The second shelf 120 may have a portion 121 connected to a carrier 210 (referred to as a “first portion” hereinafter). The first portion 121 may be provided at a lower portion of the second shelf 120 in the first state. The first portion 121 may be provided at an end of the second shelf 120 in the first direction Y.

The third shelf 130 may cover the luggage compartment 3 at a position farther ahead than the first shelf 110. The third shelf 130 may form a wide rectangular flat plate shape. The first shelf 110 may be pivotably coupled to an end 131 of the third shelf 130 (referred to as a “third end” hereinafter). The first shelf 110 and the third shelf 130 may be interconnected by fabric, leather, a hinge, and the like.

When the covering shelf 100 starts to open the luggage compartment 3 in the first state (see FIG. 3), the first end 111 is raised and, as such, the covering shelf 100 may be folded. When the covering shelf 100 starts to close the luggage compartment 3 in the second state (see FIG. 4), the first end 111 is lowered and, as such, the first shelf 110 and the second shelf 120 may be unfolded.

In both the first state (see FIG. 3) and the second state (see FIG. 4), the third shelf 130 may be maintained in a state of covering the luggage compartment 3.

The covering shelf apparatus 1000 for a vehicle according to an embodiment of the present disclosure may include an actuator 200. The actuator 200 may be provided at one of the shelf sides 10. FIG. 2 shows a state in which the actuator 200 is provided at the right shelf side 10.

Each shelf side 10 may include a space in which parts such as the actuator 200, and the like, are installed (referred to an “installation space 12” hereinafter) (see FIG. 2). A side surface 11 of the shelf side 10 may partition the luggage compartment 3 and the installation space 12 from each other.

The actuator 200 may move the covering shelf 100 to enable the covering shelf 100 to cover or open. The actuator 200 may include a carrier 210, a guide rail 220, a cable 230, and a driver 240.

The guide rail 220 may be coupled to the side surface 11 of the shelf side 10. The carrier 210 may be movably mounted to the guide rail 220. A through hole 11h may be formed at the side surface 11. The carrier 210 mounted to the guide rail 220 may be exposed to the luggage compartment 3 through the through hole 11h. The carrier 210 may be connected to the first portion 121 of the covering shelf 100 through the through hole 11h.

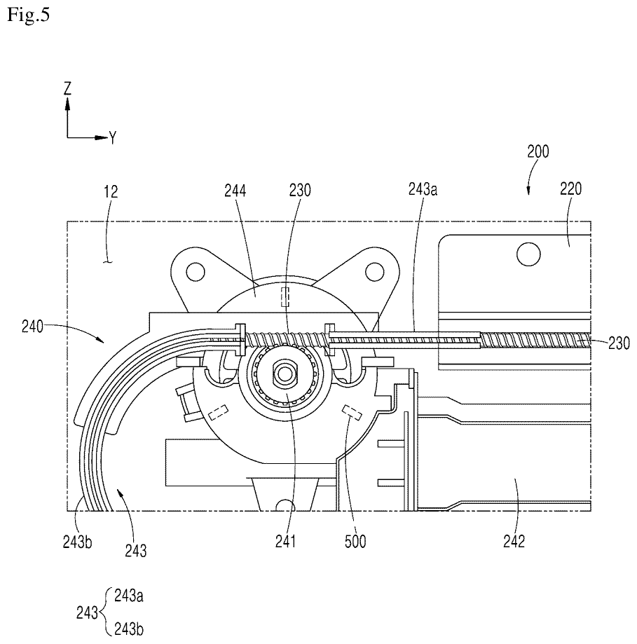

FIG. 5 is a view of the driver 240 of the covering shelf apparatus 1000 for a vehicle according to an embodiment of the present disclosure viewed at a lateral side.

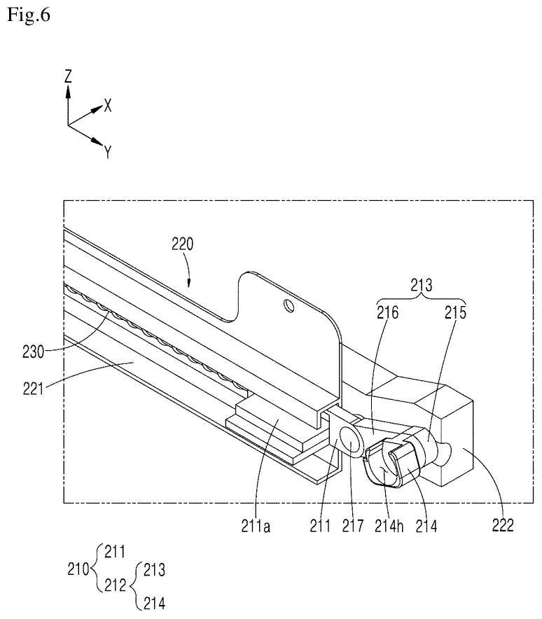

FIG. 6 is a perspective view of a part of the covering shelf apparatus 1000 for a vehicle according to an embodiment of the present disclosure, showing the carrier 210 and the guide rail 220.

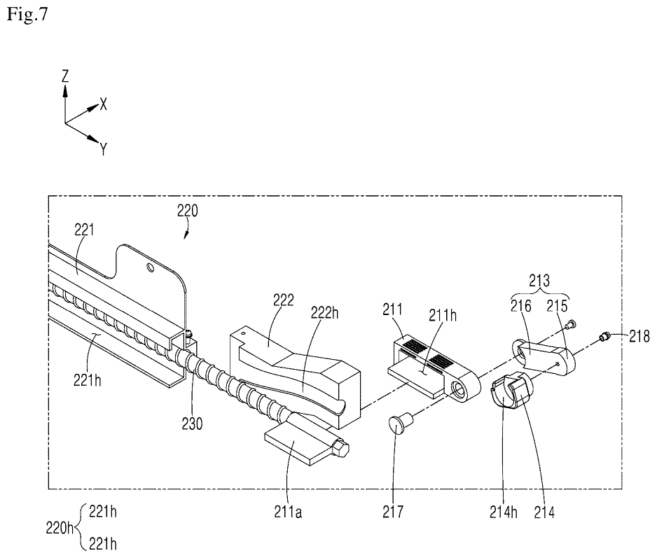

FIG. 7 is an exploded perspective view of a part of the covering shelf apparatus 1000 for a vehicle according to an embodiment of the present disclosure, showing the carrier 210 and the guide rail 220.

The guide rail 220 may be formed with a rail groove 220h extending in a longitudinal direction of the guide rail 220. The carrier 210 and the cable 230 are movably inserted into the rail groove 220h. The guide rail 220 may include a main rail 221 and a secondary rail 222.

The main rail 221 may be elongated in a straight direction. The straight direction (longitudinal direction) may be inclined downwards as the main rail 221 extends in the first direction Y.

A rail groove 221h of the main rail 221 (referred to as a “first rail groove 221h” hereinafter) may be open toward the luggage compartment 3. The cross-section of the main rail 221 may form substantially a “C” shape open toward the luggage compartment 3.

The width of the first rail groove 221h is uniform in a longitudinal direction of the main rail 221. The width of the first rail groove 221h may mean a vertical width with reference to the C-shaped cross-section. An opening of the main rail 221 open toward the luggage compartment 3 may have a smaller vertical width than the vertical width of the first rail groove 221h. Accordingly, separation of the carrier 210 and the cable 230 may be prevented.

The secondary rail 222 may be connected to an end of the main rail 221 in the first direction Y. An end of the secondary rail 222 in the first direction Y may be higher than the end of the main rail 221 in the first direction Y. The secondary rail 222 may be inclined upwards as the secondary rail 222 extends in the first direction Y.

The secondary rail 222 may be coupled to the end of the main rail 221 in the first direction Y by a bolt. Alternatively, the main rail 221 and the secondary rail 222 may be manufactured to be integrated with each other.

A rail groove 222h of the secondary rail 222 (referred to as a “second rail groove 222h” hereinafter) may be open toward the luggage compartment 3. The cross-section of the secondary rail 222 may form substantially a “C” shape open toward the luggage compartment 3.

The width of the second rail groove 222h is uniform in a longitudinal direction of the secondary rail 222. The width of the second rail groove 222h may be equal to the width of the first rail groove 221h. The width of the second rail groove 222h may mean a vertical width with reference to the C-shaped cross-section. An opening of the secondary rail 222 open toward the luggage compartment 3 may have a smaller vertical width than the vertical width of the second rail groove 222h. Accordingly, separation of the carrier 210 and the cable 230 may be prevented.

The carrier 210 may include a cable carrier 211 and a shelf carrier 212.

The cable carrier 211 may form a longitudinally-elongated rectangular parallelepiped shape. The cable carrier 211 may have a slightly smaller vertical width than the vertical width of the first rail groove 221h. Accordingly, the cable carrier 211 may move in the first rail groove 221h in the longitudinal direction of the main rail 221.

The second rail groove 222h may be inclined upwards as the second rail groove 222h extends in the first direction Y. Accordingly, movement of the rectangular parallelepiped cable carrier 211 from the first rail groove 221h to the second rail groove 222h may be restricted.

The cable carrier 211 may form a hole 211h in which a fastening piece is fitted (referred to as a “fastening hole 211h” hereinafter). When one end of the cable 230 is inserted into the cable carrier 211, the fastening piece may be coupled to (fitted in) through the fastening hole 211h. Accordingly, the end of the cable 230 may be connected to the cable carrier 211. The other end of the cable 230 may be a free end.

The shelf carrier 212 may include a carrier body 213 and a fitting 214. The carrier body 213 may include a cylindrical portion 215 and a connecting portion 216.

The cylindrical portion 215 may form a cylindrical shape having a central axis parallel to an X-axis. The cylindrical portion 215 may have a diameter slightly smaller than the width of the second rail groove 222h. Accordingly, although a bottom surface of the second rail groove 222h is inclined upwards as the second rail groove 222h extends in the first direction Y, the cylindrical portion 215 may move on the main rail 221 and the secondary rail 222.

The connecting portion 216 may extend from the cylindrical portion 215. The cable carrier 211 and the connecting portion 216 may be pivotably interconnected by a hinge (referred to as a “connecting hinge 217” hereinafter). The connecting portion 216 may form a bar shape having a thickness smaller than the diameter of the cylindrical portion 215. Accordingly, although the second rail groove 222h is inclined upwards as the second rail groove 222h extends in the first direction Y, the connecting portion 216 may move on the main rail 221 and the secondary rail 222.

The fitting 214 may be coupled to the cylindrical portion 215 by a fastener 218 such as a bolt, and the like. The fitting 214 may form a groove in which the first portion 121 is downwardly fitted (referred to as a “fitting groove 214h” hereinafter). The first portion 121 may form a cylindrical shape having a central axis parallel to the X-axis. An inner diameter of the fitting groove 214h may be slightly greater than the diameter of the first portion 121. Accordingly, the first portion 121 may be pivotably fitted in (connected to) the fitting groove 214h.

The cable 230 may be movably inserted into the rail groove 220h at the end of the guide rail 220 in the second direction. A C-shaped inner surface of the rail groove 220h may form a boundary surface restricting bending of the cable 230. Accordingly, the cable 230 may smoothly move in the rail groove 220h in the longitudinal direction of the guide rail 220.

The driver 240 may push and pull the cable 230 to enable the covering shelf 100 to cover and open the luggage compartment 3. The driver 240 may be coupled to the side surface 11 of the shelf side 10. The driver 240 may include a gear 241, a motor 242, and a cable guide 243. The gear 241 an output-side gear of a gear box 244.

The gear 241 may be spaced apart from the second-direction end of the guide rail 220 in the second direction. The cable 230 may be formed of a spiral cable. Teeth of the gear 241 may contact a twisty surface of the spiral cable.

Accordingly, the gear 241 may transmit force to the cable 230 as the gear 241 contacts the cable 230. As such, the cable 230 may be moved by the gear 241. The motor 242 may rotate the gear 241.

The cable guide 243 may guide movement of the cable 230 at an outside of the guide rail 220. The cable guide 243 may be formed of a tube into which the cable 230 is movably inserted. One side of the cable guide 243 may be coupled to the gear box 244.

One end of the cable guide 243 may be inserted into the rail groove 220h at the second-direction end of the guide rail 220. The other end of the cable guide 243 may be disposed at one side of the installation space 12 of the shelf side 10.

The cable guide 243 may include a first cable guide 243a and a second cable guide 243b. The first cable guide 243a and the second cable guide 243b may be spaced apart from each other. The cable 230 may contact the gear 241 between the first cable guide 243a and the second cable guide 243b. The first cable guide 243a may include one end of the cable guide 243. The second cable guide 243b may include the other end of the cable guide 243.

The cable guide 243 may include a straight section elongated in one direction and a curved section bent in the form of a curved line in accordance with a shape of the installation space 12. The second cable guide 243b may include the curved section.

As the radius of curvature of the curved section decreases, the bending strain and frictional force of the cable 230 may increase. Accordingly, the radius of curvature of the curved section may be determined within a range in which the bending strain and frictional force of the cable 230 do not increase load of the motor 242.

A guide tube configured to guide a movement path of the cable 230 may be installed between the guide rail 220 and the driver 240. Accordingly, the cable 230 may undergo elastic bending deformation between the guide rail 220 and the driver 240.

When the gear 241 rotates in a counterclockwise direction with reference to a first state of FIG. 3, the cable 230 may be moved on the guide rail 220 in the second direction. Accordingly, the carrier 210 may be moved on the guide rail 220 in the second direction. Accordingly, the first end 111 is raised and, as such, the covering shelf 100 is folded. As a result, the covering shelf 100 may open the luggage compartment 3.

When the cable 230 moves on the guide rail 220 in the second direction with reference to the first state of FIG. 3, the cable 230 may move in the cable guide 243 toward the other end of the cable guide 243. The other end of the cable 230 may partially protrude through an opening at the other end of the cable guide 243.

When the gear 241 rotates in a clockwise direction with reference to a second state of FIG. 4, the cable 230 may be moved on the guide rail 220 in the first direction Y. Accordingly, the carrier 210 may be moved on the guide rail 220 in the first direction Y. Accordingly, the first end 111 is lowered and, as such, the covering shelf 100 is unfolded. As a result, the covering shelf 100 may close the luggage compartment 3.

When the cable 230 moves on the guide rail 220 in the first direction Y with reference to the second state of FIG. 4, the cable 230 may move in the cable guide 243 toward one end of the cable guide 243. Thus, the movement length of the cable 230 may approximately correspond to the length of an operating range (a movement range of the carrier 210 on the guide rail 220). Accordingly, it may be possible to minimize the length of the cable 230, to reduce the number of parts, and to achieve structural simplification and weight reduction

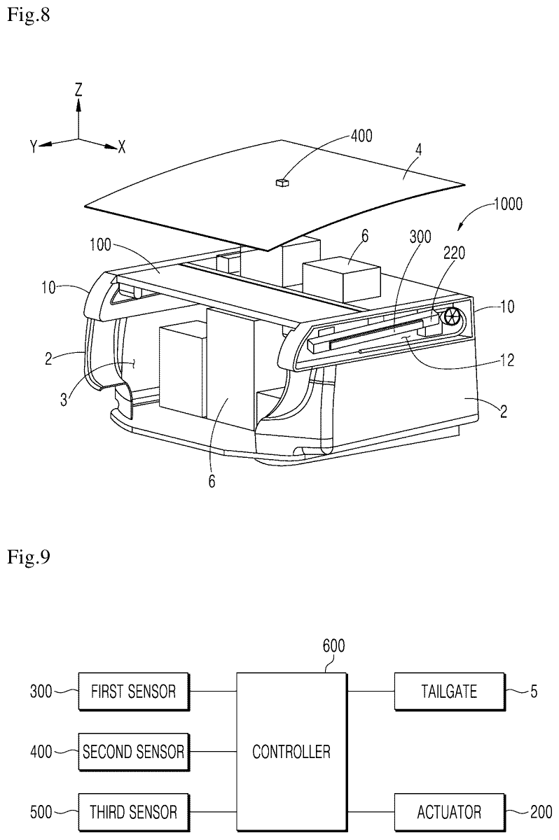

FIG. 8 is a perspective view of the covering shelf apparatus 1000 for a vehicle according to an embodiment of the present disclosure viewed at rear and top sides, showing a state in which the luggage 6 is stacked in the luggage compartment 3.

FIG. 9 is a diagram showing a controller 600, a first sensor 300, a second sensor 400, a third sensor 500, the actuator 200, and a tailgate 5 of the covering shelf apparatus 1000 for a vehicle according to an embodiment of the present disclosure.

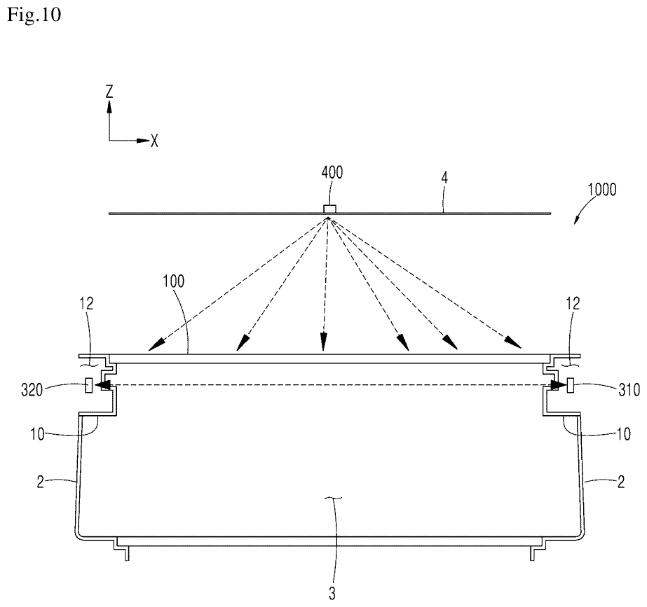

FIG. 10 is a sectional view of the covering shelf apparatus 1000 for a vehicle according to an embodiment of the present disclosure viewed at a rear side, showing a state in which the luggage 6 is not stacked in the luggage compartment 3.

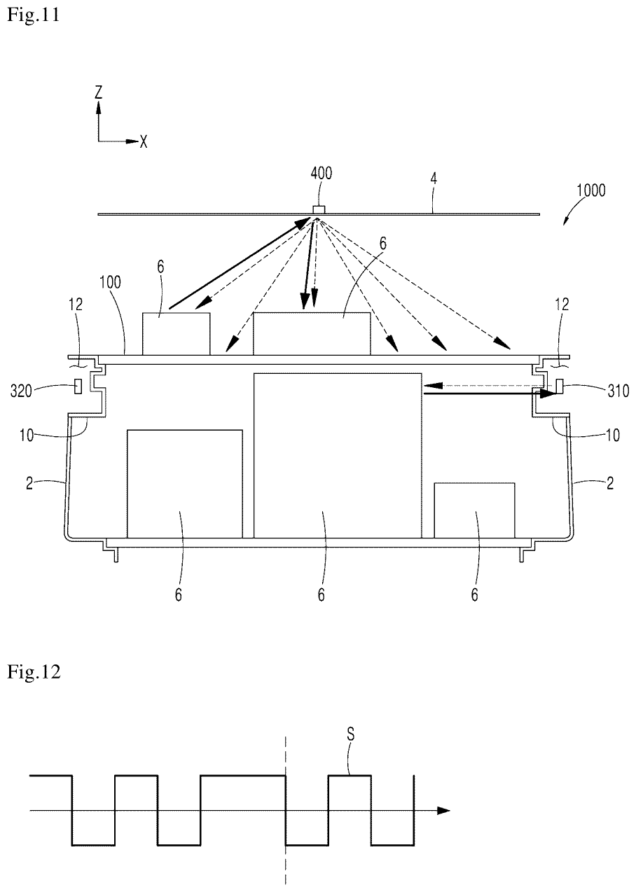

FIG. 11 is a sectional view of the covering shelf apparatus 1000 for a vehicle according to an embodiment of the present disclosure viewed at a rear side, showing a state in which the luggage 6 is stacked in the luggage compartment 3.

The first sensor 300 may be provided at the shelf sides 10. The first sensor 300 may be coupled to the guide rail 220.

The first sensor 300 may be provided as an area sensor. A light emitter 310 of the first sensor 300 may be provided at one of the shelf sides 10 respectively disposed at both sides, and a light receiver 320 of the first sensor 300 may be provided at the other of the shelf sides 10.

The light emitter 310 and the light receiver 320 may be horizontally spaced apart from each other. A through hole 10h may be formed at the side surface 11 of each shelf side 10 (see FIG. 3). Light emitted from the light emitter 310 may be incident upon the light receiver 320 after passing through the through holes 10h of the shelf sides 10.

The first sensor 300 may be provided as a photosensor in which light emitted from the light emitter 310 is incident upon the light receiver 320 after being reflected from a surface of an object.

The light emitter 310 and the light receiver 320 may be downwardly spaced apart from the covering shelf 100 by a first distance. Accordingly, the first sensor 300 may sense the luggage 6 disposed within a range of the first distance from a lower surface of the covering shelf 100. For example, the first distance may be 1 to 5 cm.

When the first sensor 300 senses luggage 6 disposed between the shelf sides 10, the first sensor 300 may generate a first sensing signal. The controller 600 may receive the first sensing signal. The controller 600 may be an electronic control unit of the vehicle. Alternatively, the controller 600 may be a separate control device configured to transmit and receive signals to and from the electronic control unit of the vehicle.

The first sensor 300 may be provided in plural. In this case, the first sensors 300 may be sequentially disposed in the longitudinal direction of the guide rail 220. Accordingly, when the luggage 6 is disposed within the range of the first distance from the lower surface of the covering shelf 100 in a space covered and opened by the covering shelf 100, each of the first sensors 300 may generate the first sensing signal.

The second sensor 400 may be provided at a headliner 4. The second sensor 400 may be coupled to an upper surface of the headliner 4. A hole, through which light from the second sensor 400 passes, may be formed at the headliner 4.

The second sensor 400 may be provided as a photosensor. Light emitted from a light emitter 310 of the second sensor 400 may be incident upon a light receiver 320 of the second sensor 400 after being reflected from an upper surface of the covering shelf 100. Accordingly, the second sensor 400 may sense the luggage 6 disposed at the upper surface of the covering shelf 100.

When the second sensor 400 senses luggage 6 laid on the upper surface of the covering shelf 100, the second sensor 400 may generate a second sensing signal. The controller 600 may receive the second sensing signal. The controller 600 may be an electronic control unit of the vehicle. Alternatively, the controller 600 may be a separate control device configured to transmit and receive signals to and from the electronic control unit of the vehicle.

When neither the first sensing signal nor the second sensing signal is generated, the controller 600 may operate the actuator 200 to enable the covering shelf 100 to cover or open the luggage compartment 3. On the other hand, when at least one of the first or second sensing signals is generated, the controller 600 may not operate the actuator 200.

Accordingly, it may be possible to automatically sense the luggage 6 disposed on the movement path of the covering shelf 100 or stacked on an upper end of the covering shelf 100 when the covering shelf 100 operates, thereby preventing damage to the covering shelf 100 and the luggage 6.

The actuator 200 may move the covering shelf 100 by drive force of the motor 242 (see FIG. 5). The third sensor 500 may be provided at the motor 242.

FIG. 12 is a diagram showing a signal S of a Hall sensor mounted to the motor 242 according to an embodiment of the present disclosure.

The third sensor 500 may be a Hall sensor. The third sensor 500 may sense a position of a rotor of the motor 242 in real time, thereby sensing a speed S of the motor 242. When the rotational speed of the motor 242 decreases (depicted by a dashed line in FIG. 12), the third sensor 500 may generate a third sensing signal.

Alternatively, the third sensor 500 may sense a variation in supply current of the motor 242.

When the first sensor 300 cannot sense the luggage 6 disposed between the shelf sides 10 or the second sensor 400 cannot sense the luggage 6 laid on the upper surface of the covering shelf 100, the third sensor 500 may sense a decrease in rotational speed of the motor 242 or an increase in supply current of the motor 242 caused by interference and weight of the luggage 6.

Accordingly, the third sensor 500 may sense the luggage 6 disposed between the shelf sides 10 or the luggage 6 laid on the upper surface of the covering shelf 100. Thus, even when the first sensor 300 and the second sensor 400 cannot sense the luggage 6 disposed between the shelf sides 10 or the luggage 6 laid on the upper surface of the covering shelf 100 due to failure, contamination, and the like, thereof, it may be possible to prevent damage to the covering shelf 100 and the luggage 6.

The controller 600 may receive the third sensing signal. The controller 600 may be an electronic control unit of the vehicle. Alternatively, the controller 600 may be a separate control device configured to transmit and receive signals to and from the electronic control unit of the vehicle.

When the third sensing signal is not generated, the controller 600 may operate the actuator 200 to enable the covering shelf 100 to cover or open the luggage compartment 3. On the other hand, when the third sensing signal is generated, the controller 600 may stop operation of the actuator 200.

Accordingly, it may be possible to automatically sense the luggage 6 disposed on the movement path of the covering shelf 100 or stacked on an upper end of the covering shelf 100 when the covering shelf 100 operates, thereby preventing damage to the covering shelf 100 and the luggage 6.

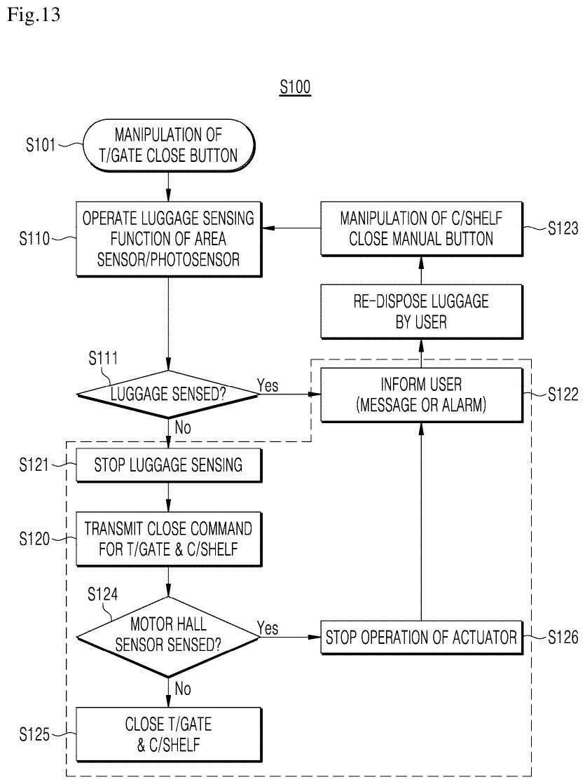

FIG. 13 is a flowchart showing a control method S100 of the covering shelf apparatus for a vehicle according to an embodiment of the present disclosure. FIG. 13 shows the control method S100 of the covering shelf apparatus for a vehicle when the tailgate 5 is closed.

The control method S100 of the covering shelf apparatus for a vehicle disclosed in the present disclosure may include an (a)-step S110 and a (b)-step S120.

The (a)-step S110 may be a step in which the first sensor 300 and the second sensor 400 operate.

When the controller 600 receives a close signal from the tailgate 5 while the tailgate 5 is in an open state (S101), the (a)-step S110 may be executed. When the user presses an OPEN/CLOSE button of the tailgate 5 while the tailgate 5 is in the open state (S101), the controller 600 may receive the close signal from the tailgate 5.

The (b)-step S120 may be a step in which, when neither the first sensing signal nor the second sensing signal is generated (S111), operation of the first sensor 300 and the second sensor 400 is stopped (S121), and the actuator 200 is operated to enable the covering shelf 100 to cover the luggage compartment 3 (S120).

The controller 600 may transmit a command to the motor 242 of the tailgate 5 to enable the tailgate 5 to be closed. Accordingly, the covering shelf 100 and the tailgate 5 may simultaneously operate.

In the (b)-step S120, when at least one of the first sensing signal or the second sensing signal is generated, the controller 600 may generate a notification signal (S122). The notification signal may be a message or an alarm. The message or the alarm may be output from an in-vehicle infotainment system of the vehicle.

The vehicle passenger may re-dispose the luggage 6 in accordance with the notification signal. When the controller 600 receives a close signal from the covering shelf 100, the (a)-step S110 may be executed again. When the user presses an OPEN/CLOSE button of the covering shelf 100 while the covering shelf 100 is in an open state (S123), the controller 600 may receive the close signal from the covering shelf 100.

In the (b)-step S120, when the third sensing signal is not generated (S124), the tailgate 5 and the covering shelf 100 close (S125). In the (b)-step S120, when the third sensing signal is generated (S124), the controller 600 may stop operation of the actuator 200 (S126), and may generate a notification signal (S122). The notification signal may be a message or an alarm. The message or the alarm may be output from the in-vehicle infotainment system of the vehicle.

The vehicle passenger may re-dispose the luggage 6 in accordance with the notification signal. When the controller 600 receives the close signal from the covering shelf 100, the (a)-step S110 may be executed again. When the user presses the OPEN/CLOSE button of the covering shelf 100 while the covering shelf 100 is in an open state (S123), the controller 600 may receive the close signal from the covering shelf 100.

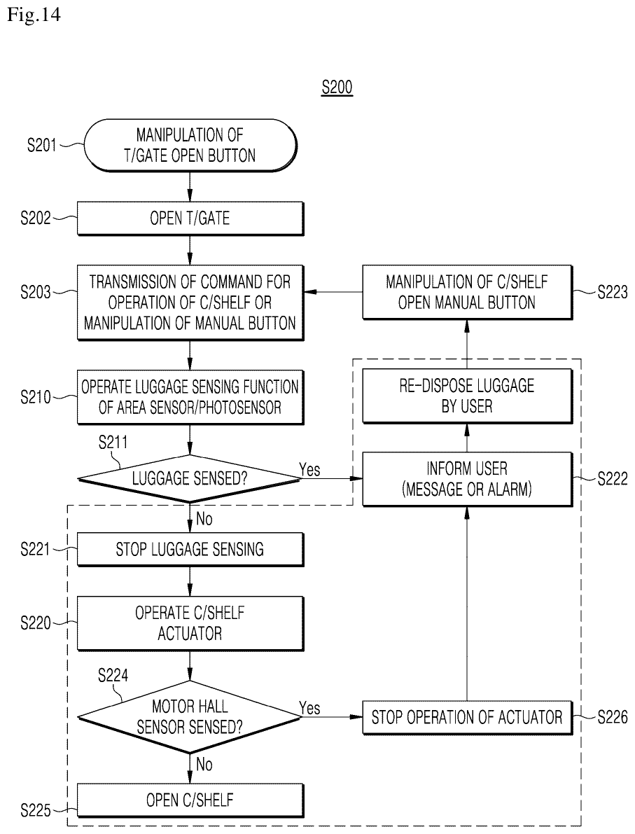

FIG. 14 is a flowchart showing a control method S200 of the covering shelf apparatus for a vehicle according to an embodiment of the present disclosure. FIG. 14 shows the control method S200 of the covering shelf apparatus for a vehicle when the tailgate 5 is opened.

The control method S200 of the covering shelf apparatus for a vehicle disclosed in the present disclosure may include an (a)-step S210 and a (b)-step S220.

The (a)-step S210 may be a step in which the first sensor 300 and the second sensor 400 operate.

When the controller 600 receives an open signal from the covering shelf 100, the (a)-step S210 may be executed. When the user presses an OPEN/CLOSE button of the covering shelf 100 while the covering shelf 100 is in a closed state (S203), the controller 600 may receive the open signal from the covering shelf 100.

Otherwise, when the controller 600 receives an open signal from the tailgate 5 while the tailgate 5 is in a closed state (S201), the controller 600 transmits a command to the actuator 200 under the condition that the tailgate 5 is opened, to execute the (a)-step S210.

The (b)-step S220 may be a step in which, when neither the first sensing signal nor the second sensing signal is generated (S211), operation of the first sensor 300 and the second sensor 400 is stopped (S221), and the actuator 200 is operated to enable the covering shelf 100 to open the luggage compartment 3 (S220).

In the (b)-step S220, when at least one of the first sensing signal or the second sensing signal is generated, the controller 600 may generate a notification signal (S222). The notification signal may be a message or an alarm. The message or the alarm may be output from the in-vehicle infotainment system of the vehicle.

The vehicle passenger may re-dispose the luggage 6 in accordance with the notification signal. When the controller 600 receives an open signal from the covering shelf 100 (S203), the (a)-step S210 may be executed again. When the user presses the OPEN/CLOSE button of the covering shelf 100 while the covering shelf 100 is in a closed state (S223), the controller 600 may receive the open signal from the covering shelf 100 (S203).

In the (b)-step S220, when the third sensing signal is not generated (S224), the covering shelf 100 opens (S225). In the (b)-step S220, when the third sensing signal is generated (S224), the controller 600 may stop operation of the actuator 200 (S226), and may generate a notification signal (S222). The notification signal may be a message or an alarm. The message or the alarm may be output from the in-vehicle infotainment system of the vehicle.

The vehicle passenger may re-dispose the luggage 6 in accordance with the notification signal. When the controller 600 receives the open signal from the covering shelf 100 (S203), the (a)-step S210 may be executed again. When the user presses the OPEN/CLOSE button of the covering shelf 100 while the covering shelf 100 is in the closed state (S223), the controller 600 may receive the open signal from the covering shelf 100 (S203).

As apparent from the above description, in accordance with the covering shelf apparatus for a vehicle according to an embodiment of the present disclosure, the first sensor may generate the first sensing signal upon sensing luggage disposed between the shelf sides. The controller may receive the first sensing signal. The second sensor may generate the second sensing signal upon sensing luggage laid on the upper surface of the covering shelf. The controller may receive the second sensing signal. When neither the first sensing signal nor the second sensing signal is generated, the controller may operate the actuator to cover or open the luggage compartment. On the other hand, when at least one of the first sensing signal or the second sensing signal is generated, the controller may not operate the actuator. Accordingly, it may be possible to automatically sense the luggage disposed on the movement path of the covering shelf or stacked on the upper end of the covering shelf when the covering shelf operates, thereby preventing damage to the covering shelf and the luggage.

In accordance with the covering shelf apparatus for a vehicle according to an embodiment of the present disclosure, when the first sensor cannot sense the luggage disposed between the shelf sides or the second sensor cannot sense the luggage laid on the upper surface of the covering shelf, the third sensor may sense a decrease in rotational speed of the motor or an increase in supply current of the motor caused by interference and weight of the luggage. Accordingly, the third sensor may sense the luggage disposed between the shelf sides or luggage laid on the upper surface of the covering shelf. Thus, even when the first sensor and the second sensor cannot sense the luggage disposed between the shelf sides or the luggage laid on the upper surface of the covering shelf due to failure, contamination, and the like, thereof, it may be possible to prevent damage to the covering shelf and the luggage.

In accordance with the control method for the covering shelf apparatus for a vehicle according to an embodiment of the present disclosure, the (a)-step may be executed when the controller receives a close signal from the tailgate. The (b)-step may include stopping operation of the first sensor and the second sensor when neither the first sensing signal nor the second sensing signal is generated, and operating the actuator to enable the covering shelf to cover the luggage compartment The controller may transmit a command to the motor of the tailgate to enable the tailgate to be closed. Accordingly, the covering shelf and the tailgate may simultaneously operate. As operating structures of the covering shelf and the tailgate are linked to each other, it may be possible to open or close the covering shelf in linkage with the tailgate when the tailgate is opened or closed.

In accordance with the control method for the covering shelf apparatus for a vehicle according to an embodiment of the present disclosure, in the (b)-step, when at least one of the first sensing signal or the second sensing signal is generated, the controller may generate a notification signal. The notification signal may be a message or an alarm. The message or the alarm may be output from an in-vehicle infotainment system of the vehicle. Accordingly, it may be possible to automatically inform the user of the luggage disposed on the movement path of the covering shelf or stacked on the upper end of the covering shelf. The vehicle passenger may re-dispose the luggage in accordance with the notification signal.

In accordance with the control method for the covering shelf apparatus for a vehicle according to an embodiment of the present disclosure, in the (b)-step, when the third sensing signal is generated, the controller may stop operation of the actuator and may generate a notification signal. The notification signal may be a message or an alarm. The message or the alarm may be output from the in-vehicle infotainment system of the vehicle. Accordingly, it may be possible to automatically inform the user of the luggage disposed on the movement path of the covering shelf or stacked on the upper end of the covering shelf. The vehicle passenger may re-dispose the luggage in accordance with the notification signal. Thus, even when the first sensor and the second sensor cannot sense the luggage disposed between the shelf sides or the luggage laid on the upper surface of the covering shelf due to failure, contamination, and the like, thereof, it may be possible to prevent damage to the covering shelf and the luggage.

In accordance with the control method for the covering shelf apparatus for a vehicle according to an embodiment of the present disclosure, when the controller receives an open signal from the tailgate while the tailgate is in a closed state, the controller transmits a command to the actuator under the condition that the tailgate is opened, to execute the (a)-step. The (a)-step may be a step of operating the first sensor and the second sensor. The (b)-step may include stopping operation of the first sensor and the second sensor when neither the first sensing signal nor the second sensing signal is generated, and operating the actuator to enable the covering shelf to open the luggage compartment. Accordingly, the covering shelf and the tailgate may simultaneously operate. As operating structures of the covering shelf and the tailgate are linked to each other, it may be possible to open or close the covering shelf in linkage with the tailgate when the tailgate is opened or closed.

In accordance with the control method for the covering shelf apparatus for a vehicle according to an embodiment of the present disclosure, in the (b)-step, when at least one of the first sensing signal or the second sensing signal is generated, the controller may generate a notification signal. The notification signal may be a message or an alarm. The message or the alarm may be output from an in-vehicle infotainment system of the vehicle. Accordingly, it may be possible to automatically inform the user of the luggage disposed on the movement path of the covering shelf or stacked on the upper end of the covering shelf. The vehicle passenger may re-dispose the luggage in accordance with the notification signal.

In accordance with the control method for the covering shelf apparatus for a vehicle according to an embodiment of the present disclosure, in the (b)-step, when the third sensing signal is generated, the controller may stop operation of the actuator and may generate a notification signal. The notification signal may be a message or an alarm. The message or the alarm may be output from the in-vehicle infotainment system of the vehicle. Accordingly, it may be possible to automatically inform the user of the luggage disposed on the movement path of the covering shelf or stacked on the upper end of the covering shelf. The vehicle passenger may re-dispose the luggage in accordance with the notification signal. Thus, even when the first sensor and the second sensor cannot sense the luggage disposed between the shelf sides or the luggage laid on the upper surface of the covering shelf due to failure, contamination, and the like, thereof, it may be possible to prevent damage to the covering shelf and the luggage.

While embodiments of the present disclosure have been illustrated and described above, the present disclosure is not limited to the specific embodiments described above. Naturally, various modifications can be made within the scope of the present disclosure by persons having ordinary knowledge in the technical field to which the disclosure belongs, and such modifications should not be understood individually from the technical idea and prospects of the present disclosure, and is within the scope of the present disclosure as claimed in the claims.

What is claimed is:

1. A covering shelf apparatus for a vehicle, the covering shelf apparatus comprising:
shelf sides provided at a left side and a right side of a luggage compartment, respectively;
an actuator provided at one of the shelf sides and configured to move a covering shelf to enable the covering shelf to open or close the luggage compartment;
a first sensor provided at the shelf sides and configured to generate a first sensing signal by sensing luggage disposed between the shelf sides;
a second sensor provided at a headliner and configured to generate a second sensing signal by sensing luggage laid on an upper surface of the covering shelf; and
a controller configured to operate the actuator when neither the first sensing signal nor the second sensing signal is generated.

2. The covering shelf apparatus according to claim 1, wherein
the first sensor is an area sensor,
an emitter of the first sensor is provided at a first side of the shelf sides, and
a receiver of the first sensor is provided at a second side of the shelf sides.

3. The covering shelf apparatus according to claim 1, wherein the second sensor is a photosensor.

4. The covering shelf apparatus according to claim 1, wherein
the actuator is configured to move the covering shelf by drive force of a motor.

5. The covering shelf apparatus according to claim 4, further comprising: a third sensor provided at the motor and configured to generate a third sensing signal when a rotational speed of the motor decreases,
wherein the controller is configured to operate the actuator when the third sensing signal is not generated.

6. The covering shelf apparatus according to claim 1, wherein the actuator comprises:
a carrier connected to a first portion of the covering shelf;
a guide rail coupled to the shelf sides and configured to enable the carrier to be movably mounted to the guide rail;
a cable including a first end connected to the carrier, and a second end being a free end; and
a driver configured to push and pull the cable to enable the covering shelf to cover or open the luggage compartment.

7. The covering shelf apparatus according to claim 6, wherein the cable is a spiral cable.

8. The covering shelf apparatus according to claim 7, wherein the driver comprises:
a gear configured to transmit force to the cable while contacting the cable; and
a motor configured to rotate the gear.

9. A control method for a covering shelf apparatus, where the covering shelf apparatus
comprises: shelf sides respectively provided on sides of a luggage compartment, an actuator configured to move a covering shelf, a first sensor provided at the shelf sides, a second sensor provided at a headliner, and a controller configured to control the actuator, the control method comprises:
respectively operating, by the controller, the first sensor to generate a first sensing signal by sensing luggage disposed between the shelf sides and the second sensor to generate a second sensing signal by sensing luggage placed on a surface of the covering shelf; and
based on a determination that neither the first sensing signal nor the second sensing signal is generated, after stopping the operation of the first sensor and the second sensor, operating, by the controller, the actuator to enable the covering shelf to cover or open the luggage compartment.

10. The control method according to claim 9, wherein operating the first sensor and the second sensor is performed based on a close signal received from a tailgate during the tailgate is in an open state.

11. The control method according to claim 9, wherein operating the actuator comprises:
based on a determination that at least one of the first sensing signal or the second sensing signal is generated, generating, by the controller, a notification signal.

12. The control method according to claim 11, further comprising: based on a determination that the controller receives a close signal from the covering shelf, reoperating the first sensor and the second sensor.

13. The control method according to claim 9, further comprising:
moving, by the actuator, the covering shelf by drive force of a motor; and
generating, by a third sensor, a third sensing signal based on a determination that a rotational speed of the motor decreases.

14. The control method according to claim 13, further comprising: based on a determination that the third sensing signal is generated, stopping the operation of the actuator; and
based on a determination that the controller receives a close signal from the covering shelf, reoperating the first sensor and the second sensor.

15. The control method according to claim 9, further comprising: reoperating the first sensor and the second sensor based on a determination that the controller receives an open signal from the covering shelf.

16. The control method according to claim 9, further comprising: reoperating the first sensor and the second sensor based on a determination that the controller receives an open signal from a tailgate during the tailgate is in a closed state.

17. The control method according to claim 9, wherein, in operating the actuator, based on a determination that at least one of the first sensing signal or the second sensing signal is generated, generating, by the controller, a notification signal, and reoperating the first sensor and the second sensor based on a determination that the controller receives an open signal from the covering shelf.

18. The control method according to claim 9, further comprising:
moving, by the actuator, the covering shelf by drive force of a motor; and
generating, by a third sensor provided at the motor, a third sensing signal based on a determination that a rotational speed of the motor decreases.

19. The control method according to claim 18, further comprising: based on a determination that the third sensing signal is generated, stopping the operation of the actuator; and
reoperating the first sensor and the second sensor based on a determination that the controller receives an open signal from the covering shelf.
